(19) United States
(12) Patent Application Publication
(10) Pub. No.: US 2011/0060639 A1
(43) Pub. Date: Mar. 10, 2011

(54) METHOD FOR FINANCING THE ACQUISITION OF AN ASSET FOR MEMBERS OF A GROUP

(76) Inventor: Alfredo Garcia, Humble, TX (US)

(21) Appl. No.: 12/556,470

(22) Filed: Sep. 9, 2009

(51) Int. Cl. G06Q 40/00; G06Q 30/00

(52) U.S. Cl. 705/14.35; 705/39

(57) ABSTRACT

A system for financing the acquisition of an asset or service is provided herein. The system (100) comprises a plurality of groups G₁, . . . , Gₖ (103, . . . , 105) wherein, for i=1 to k, group Gᵢ consists of mᵢ members (107, 109, 111, 113), each of whom are contractually obligated to make a predetermined number of periodic payments to a common fund Fᵢ. A managing entity (101) manages the plurality of groups. The system is organized such that, for each group, the managing entity allocates to members of the group, on a rotating basis and on dᵢ different dates, proceeds from the common fund Fᵢ for the acquisition of assets or services, wherein mᵢ>dᵢ>0.

### CROSS REFERENCE TO RELATED APPLICATIONS

This application claims the benefit of priority from U.S. Utility application Ser. No. 10/790,639, filed Feb. 28, 2004, now pending, having the same title, and having the same inventors, and which is incorporated herein by reference in its entirety, which application claims the benefit of priority from U.S. Provisional Application No. 60/450,776, filed Feb. 28, 2003, now expired, having the same title, and having the same inventors, and which is incorporated herein by reference in its entirety; and this application also claims the benefit of priority to U.S. Provisional Application No. 60/469,549, filed May 9, 2003, now expired, having the same title, and having the same inventors, and which is incorporated herein by reference in its entirety.

### FIELD OF THE INVENTION

The present invention relates generally to methods for financing the acquisition of assets, and more particularly to rotating credit associations and methods for operating the same.

### BACKGROUND OF THE INVENTION

The number of racial and ethnic minority households in the United States is currently increasing at a rapid rate. During the 1990s, minorities accounted for almost 70% of the total growth in the U.S. population. The U.S. Census Bureau projects that this number will continue to increase rapidly, with minorities accounting for almost 80% of the total population increase in the first decade of the 21^{st} century. A. I. Schoenholz et al., “Reaching Emerging and Underserved Home Ownership Markets”, Local Initiatives Support Coalition (Mar. 21, 2003). Much of this growth is expected to come from foreign-born minority immigrants. This group, which already accounts for 1 out of every 9 Americans, Id., faces unique obstacles in their pursuit for home ownership.

These obstacles are underscored by statistics recently compiled by the U.S. Bureau of the Census. As of October 2001, Hispanic home ownership rates were about 48.1%. This is significantly lower than the overall home ownership rate in the United States (68.1%), and is even lower than the home ownership rate for whites (74.6%). While lower median salaries are often cited as the cause for this discrepancy, recent studies suggest that these differences in homeownership rates are more closely tied to other factors, including lack of consumer education, racial or ethnic discrimination, and rigid mortgage underwriting criteria. See, e.g., E. Hizel et al., “Increasing Hispanic Homeownership: Strategies for Programs and Public Policy”, National Council of La Raza Issue Brief, No. 7 (June 2002).

The inflexibility of mortgage underwriting criteria is especially problematic for foreign-born immigrants. These criteria, which are commonly used in the approval process for consumer loans in the United States, are predicated in part on the existence of a suitable and verifiable credit history on the part of the applicant. However, many minorities, especially those who are recent immigrants, do not have a suitable credit history due, for example, to the emphasis on cash-based economies in their countries of origin. Since the underwriting process prevalent in the United States is not flexible enough to account for such nontraditional credit histories, these applicants are frequently rejected for mortgages and other consumer loans without any true consideration of their inherent credit worthiness. Moreover, for many of those minorities who do have sufficient credit histories and who would otherwise be eligible for consumer loans, their inexperience with, and consequent lack of understanding of, credit problems and the remediation thereof often leads to credit issues that result in loan rejections.

As a result of the above noted factors, many minorities and immigrants have had to rely on nontraditional methods for acquiring homes and other assets. For example, in one recent survey of African American homeowners in Syracuse, N.Y., more than one half of those surveyed had purchased a home at auction or through other nontraditional methods that are not governed by rigid underwriting criteria. NC State University, “Barriers to Homeowners for Minorities and Immigrants”, The Forum for Family and Consumer Issues, Vol. 2, No. 3 (Summer 1997).

One type of nontraditional method that has been used for the acquisition of assets are the variety of self-financing schemes that are known generically in the literature as “rotating credit associations” (RCAs), or sometimes as “rotating credit and savings associations” (ROSCAs). RCAs are described, for example, in C. Achua and R. Lussier, “A Nonmarket Institution Creates the Opportunity for Small Business Financing”, submitted for presentation at the 1999 Small Business Institute Director's Association National Conference in San Francisco, Calif. As this paper notes, an RCA typically involves a group of participants who agree to make regular contributions to a common fund. Proceeds from the fund are then given, in whole or in part, to each contributor in rotation. These funds are typically used for the purchase of durable goods, including homes, or to purchase inventory or equipment for the launch of new businesses. In some countries, RCAs serve as an important source of seed capital for small entrepreneurs who cannot get loans from formal financial institutions. RCAs, and self-financing associations of a similar nature, are known by many different names in various countries, and include chit funds in India, Hui in China, Ko in Japan, Susu in Ghana, Njangi in Cameroon, Kye in Korea, Tontines in Senegal, Esusu in Nigeria, the Bolivian pasanaqu, the Peruvian pandero, and the ronda in Mexico.

As indicated above, RCAs have developed into a staple of informal financing mechanisms around the world. They offer a means to accumulate savings, and to access credit, for individuals and small business owners who may otherwise be excluded from, or who do not have access to, more formal savings and credit systems. Hence, RCAs offer one potential solution to the above-noted problems faced by minorities and immigrants in purchasing homes and other assets. However, RCAs have some significant infirmities that have hindered their development into a viable and commonly available financing option. This is especially so in countries such as the United States, where RCAs would have to compete with sophisticated consumer credit markets.

One of the major problems with RCAs arises from the viability and liquidity issues they face when participants cancel their membership in the association and/or default on their contributions. These issues can have unforeseen and far-reaching consequences. In particular, in order to achieve economies of scale, the organizers of RCAs often find it necessary to operate several RCAs concurrently. This often results in a highly networked system in which the financial health of any one RCA in the system is linked to the health of the others. Consequently, member cancellations or defaults in contributions in a single RCA can have a domino effect that is often both wide-spread and catastrophic. Hence, in one documented case that occurred in the district of Wenzhou in the Zhenjiang Province of China, over 360 households lost a total of 1.1 million yuan (about $122,000) due to a single default in a hui. K. S. Tsai, “A Circle Of Friends, A Web Of Troubles: —Rotating Credit Associations In China”, Harvard China Review Magazine Online, Vol. 1, No. 1 (Summer 1998).

There is thus a need in the art for a system and method of self financing that overcomes the above noted infirmities. In particular, there is a need in the art for a system and method of self-financing that offers an attractive alternative to conventional consumer credit and savings systems for persons, such as immigrants and minorities, who may have nontraditional credit histories or who are otherwise disadvantaged in the underwriting processes commonly used as the basis for consumer loans. There is also a need in the art for a system and method of self-financing that can tolerate a high number of cancellations and defaults by its contributing members without becoming insolvent or nonviable. These and other needs are met by the present invention, as hereinafter described.

### SUMMARY OF THE INVENTION

In one aspect, a system is provided for financing the acquisition of an asset or service. The system comprises a plurality of groups G₁, . . . , Gₖ wherein, for i=1 to k, group Gᵢ consists of mᵢ members, each of whom are contractually obligated to make a predetermined number of periodic payments to a common fund F. The system also comprises a managing entity which manages the plurality of groups. For each group, the managing entity allocates to members of the group, on a rotating basis and on dᵢ different dates, proceeds from the common fund Fᵢ for the acquisition of assets or services, such that mᵢ>dᵢ>0. Preferably, each member of each group contracts to be allocated a predetermined amount of money, and the total payments made by a member is proportional to the amount of money the member contracts to be allocated. More preferably, each member of each group is allocated money exactly once. The amount of money a member of a group is allocated may be a fixed percentage of the total payments made by that member. Preferably, the managing entity allocates to a member of a group proceeds from the common fund for the acquisition of an asset, and retains a lien in the asset until the member makes all of the predetermined number of periodic payments. The predetermined number of periodic payments may be the same for each member of a group, or may be different for at least two members of a group. Preferably, the system is implemented such that mᵢ/dᵢ>1.5, more preferably such that mᵢ/dᵢ≧2, and most preferably such that 2≦mᵢ/dᵢ≦3. Preferably, mᵢ>100, and more preferably, 100<mᵢ<300. Most preferably, mᵢ>100 and mᵢ/dᵢ>1.5.

In another aspect, a method for financing the acquisition of an asset or service for members of a group is provided. The method comprises the steps of creating a group of associates, each of whom is contractually obligated to make payments on a first periodic basis to a common fund over a specified term in exchange for receiving an award in a contracted amount at some point during the term; receiving payments from the group of associates; and on a second periodic basis, identifying at least one associate who is eligible to receive an award, and distributing the award to that associate in an amount essentially equal to the amount contracted by that associate; wherein the number of associates in the group is x, wherein the average number of payments that an associate in the group is required to make is n, and wherein x/n>1. Preferably, x/n≧1.5, more preferably, x/n≧2, and most preferably, 2≦x/n≦3. In some embodiments, the periods of the first and second periodic bases are essentially the same, and are monthly. Preferably, the number of associates is within the range of about 200 to about 300, and the average number of payments that an associate in the group is required to make is within the range of about 96 to about 120.

In yet another aspect, a method for financing the acquisition of an asset or service for members of a group is provided. The method comprises the steps of: creating a group of associates, each of whom is contractually obligated to make predetermined monthly payments to a common fund over a specified term in exchange for receiving an award in a contracted amount at some point during the term, wherein the number of associates is within the range of about 200 to about 300, and wherein the fixed term is within the range of about 96 to about 120 months; receiving payments from the group of associates; and, on a monthly basis, identifying at least one associate who is eligible to receive an award, and then distributing the award to that associate in an amount essentially equal to the amount contracted by that associate. The fixed term and/or the contracted amount may be different for at least two associates in the group. The fund may be managed by a first organization, and payments to the organization may be arranged such that each associate pays the first organization a fixed percentage of the amount contracted by that associate as a registration fee. The fund may be managed by a first organization, and the monthly payment made by each associate may include an administrative fee that may be a percentage of the monthly payment increases with the contracted amount. The administrative fee is preferably within the range of about 5.5 to about 7.5% of the monthly payment made by the associate, but may also be a function of, or be defined by, an economic index, factor, or lending rate. Thus, for example, the administrative fee may be based on the prevailing prime lending rate. The monthly payment owed by an associate may include a component which is calculated by dividing the sum of the contracted amount and an actualization factor by the number of months in the term. The contracted amount may be increased on a periodic basis by applying the actualization factor to the previous contracted amount. The periodic basis is preferably annually, and the actualization factor is preferably within the range of about 1 to about 5% of the contracted amount. The actualization factor may reflect the increase in value of the asset or service being procured by the associate. The fund may be managed by a first organization which takes out a life insurance policy on each associate, and the monthly payment owed by an associate may include the prorated monthly cost of the life insurance premium. Alternatively, the fund may be managed by a first organization which takes out a life insurance policy on each associate, and wherein the monthly payment owed by an associate includes a first component essentially equal to the prorated monthly cost of the life insurance premium, a second component which is essentially equal to the sum of the contracted amount and an actualization factor divided by the number of months in the term, and a third component which is essentially equal to an administrative fee that varies as a function of the contracted amount. The amount contracted by any associate is preferably no more than about three times the amount contracted by any other associate. Preferably, an associate is eligible to receive an award if the associate is not delinquent in any monthly payments. It is also preferred that the distribution of rewards to associates commences no later than four months after the beginning of the term. A computer program or suit may also be provided that is adapted to implement the foregoing method. The program or suit may be disposed in a compact or floppy disk or in another suitable tangible medium.

In still another aspect, a method is provided for financing the acquisition of an asset or service for members of a group. In accordance with the method, payments are received from a group of x members over a fixed period of time t and on a periodic basis essentially given by t/n, wherein x and n are integers, and wherein x>n; and funds are allocated, over the period of time t, on a rotating basis to the members of the group for the acquisition of assets or services. Possible assets include those selected from the group consisting of houses, computers, vehicles, and travel packages.

In yet another aspect, a method is provided for financing the acquisition of an asset by an applicant through the procurement of credit from a creditor that has a set of underwriting criteria associated therewith that must be met in order for the creditor to advance money to the applicant, and wherein the applicant does not meet all of the underwriting criteria. The method comprises the step of enrolling the applicant in a rotating credit association (RCA), the RCA being adapted such that, through membership in the RCA, the applicant will meet, or come to meet, at least some of the underwriting criteria. The RCA is preferably an RCA of the type described herein, but other types of RCAs may also be used for these purposes. In some embodiments, through his membership in the RCA, the applicant contracts to be allocated a predetermined amount of money in exchange for making a specified number of predetermined payments. The underwriting criteria may require an applicant to have a history of making a given number of timely payments on a financial obligation, and this criteria may be met by the payments that the applicant is required to make to the RCA. The underwriting criteria may permit the contract to be used as collateral for a loan from the creditor to the applicant. In some embodiments, the members of the RCA contract to be allocated a predetermined amount of money in exchange for making a predetermined number of payments, the underwriting criteria require a specified amount of collateral, and the contract entered into by members of the RCA qualifies as collateral under the underwriting criteria.

In another aspect, a method is provided for qualifying an applicant for a loan from a lender having a set of underwriting criteria that must be met in order for the lender to loan money to the applicant. The method comprises the steps of referring the applicant to a rotating credit association (RCA) whose members contract to be allocated a predetermined amount of money in exchange for making a specified number of predetermined payments, and using the applicant's participation in the RCA to meet at least some of the underwriting criteria. The RCA may be affiliated with the lender, the RCA and the lender may be commonly owned, or the RCA may be a subsidiary of the lender. The step of using the applicant's participation in the RCA to meet at least some of the underwriting criteria may include the step of allowing the contract that the applicant enters into as a member of the RCA to be used as collateral for a loan from the lender to the applicant.

In some embodiments, the underwriting criteria may require a payment history of at least 12 consecutive payments on a financial obligation, and the step of using the applicant's participation in the RCA to meet at least some of the underwriting criteria may include the step of using the applicant's payments to the RCA to meet the requirement of a payment history of at least 12 consecutive payments on a financial obligation. After the applicant meets the underwriting criteria, the lender may extend credit to the applicant in the form of a loan, a line of credit, or a credit card.

In still another aspect, a business affiliation is provided, comprising a lender having a set of underwriting criteria that must be met in order for the lender to loan money to an applicant, and a rotating credit association (RCA) affiliated with said lender and whose members contract to be allocated a predetermined amount of money in exchange for making a specified number of predetermined payments, wherein an applicant's membership in the RCA enables him to qualify for a loan from the lender. The underwriting criteria may require a payment history of at least 12 consecutive payments on a financial obligation, and this criteria may be met by the payments that the applicant makes to the RCA.

In another aspect, a method is provided for qualifying an applicant for a loan from a lender having a set of underwriting criteria that must be met in order for the lender to loan money to the applicant. The method comprises the steps of providing a rotating credit association (RCA) affiliated with the lender whose members contract to be allocated a predetermined amount of money in exchange for making a specified number of predetermined payments; enrolling the applicant in the RCA; and using the applicant's participation in the RCA to meet at least some of the underwriting criteria.

In a further aspect, a system for financing the acquisition of an asset is provided, comprising a creditor having a set of requirements associated therewith that must be met in order for the creditor to advance money to a debtor, and a rotating credit association (RCA) associated with the creditor, said RCA having a plurality of members that do not meet the set of requirements as of the date they become members of the RCA, and wherein the participation of the plurality of members in the RCA enables them to meet the creditor's requirements.

These and other aspects of the present invention are described in further detail below.

### DESCRIPTION OF THE FIGURES

FIG. 1 is a schematic diagram illustrating the configuration of one embodiment of a rotating credit association established in accordance with the principles described herein; and.

FIG. 2 is a flow chart illustrating one embodiment of the methodology disclosed herein.

### DETAILED DESCRIPTION

It has now been found that the above noted needs may be met by constructing a system and method for self-financing along the lines of a rotating credit association in which the number of members making payments to the association is greater than the number of time intervals (typically months) and/or dates over which payments are made or over which awards are granted. By operating the rotating credit association in this manner, the association can tolerate a higher number of cancellations and defaults by its contributing members than would otherwise be the case. The viability and solvency of the rotating credit association may be further improved by other features as are described herein, such as, for example, the retention of a lien by the association (or its management) in any assets purchased with distributions from the association until such time that the member receiving the distribution has made all required payments to the association.

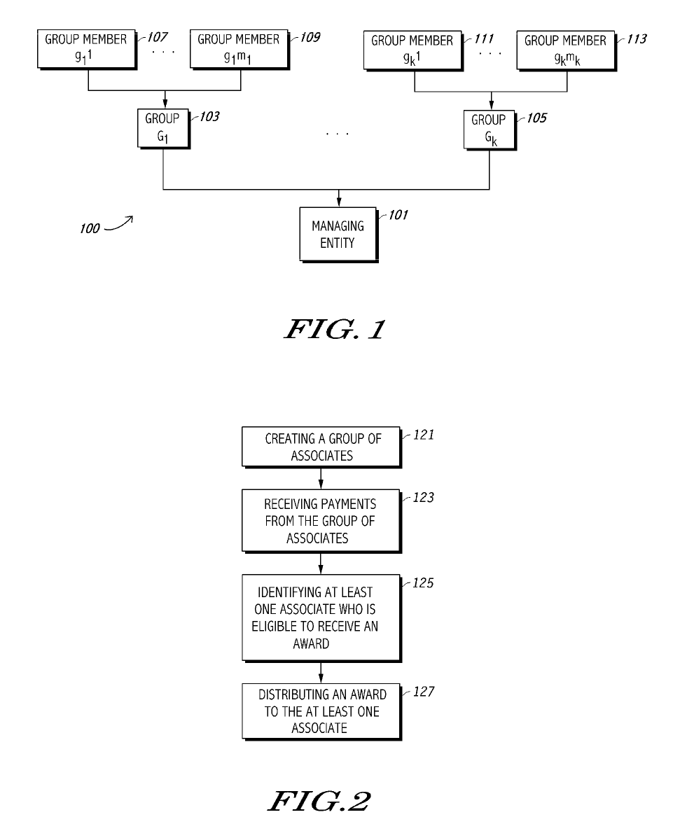

FIG. 1 illustrates one possible embodiment of a rotating credit association of the type disclosed herein. The rotating credit association 100 depicted therein consists of a managing entity 101 which manages k different groups (denoted as groups G₁ 103 to Gₖ 105) of members. The managing entity may comprise more than one distinct components, and may thus consist of, for example, a non-profit promotional entity, and a for-profit corporation which oversees the daily operations of the association. Groups G₁ 103 to Gₖ 105 have m₁ to mₖ members, respectively. For reference purposes, the y^{th} member of group Gₓ may be designated herein as member g_{xy}. Thus, the first member 107 of group G₁ 103 may be designated as member g₁₁, and the last member 109 of group G₁ 103 may be designated as member g₁ₘ₁. Similarly, the first member 111 of group Gₖ 105 may be designated as member gₖ₁, and the last member 109 of group Gₖ 103 may be designated as member gₖₘₖ.

The rotating credit association is arranged such that the managing entity 101 receives payments from each of the k groups. For a particular group Gᵢ, each of the mᵢ members of that group makes payments on a periodic basis to a common fund Fᵢ. Each of the common funds of the groups in the rotating credit association 100 may be maintained in separate accounts, or the money from the common funds of two or more groups in the rotating credit association may be intermingled, but in any case, the funds are preferably tracked on a group-by-group basis. The funds from the common fund Fᵢ are then allocated or awarded to members of the group Gᵢ on a rotating basis (that is, in such a manner that each member of group Gᵢ receives funds in turn, and typically in such a manner that each member of group Gᵢ is awarded funds exactly once), and on dᵢ different dates or over dᵢ different intervals, for the acquisition of assets. Typically, the awards are made on a zero-sum basis (that is, the total amount of money paid out in awards to members of group Gᵢ is essentially equal to the total amount of money paid in by the members of that group, excluding management fees and other such expenses). Also, group Gᵢ is assembled such that mᵢ>dᵢ>0. As noted above, this feature allows the association to tolerate a higher number of cancellations and defaults by its contributing members than would otherwise be the case.

FIG. 2 illustrates some of the basic steps in one embodiment of the methodology disclosed herein for establishing and/or managing a group of members in a rotating credit association established along the lines of the principles described herein. In accordance with the methodology depicted in FIG. 2, a group of members or associates is created 121. This group may be one of k groups, as described above. Payments are then received 123 from the members of the group, typically on a first periodic basis. Then, on a second periodic basis (which may be the same or different from the first periodic basis), at least one associate is identified 125 in the group who is eligible to receive an award. As described in greater detail below, eligibility may be predicated, for example, on being current in all required contributions or payments. An award is then distributed 127 to the at least one associate. As noted above, the group is typically assembled such that the number of members in the group is the number of dates or intervals over which awards are made is dᵢ, and mᵢ>dᵢ>0.

The rotating credit associations and methodologies described herein may be further understood with reference to the following specific, non-limiting example.

### Example 1

This example illustrates the basic set-up of one particular, non-limiting embodiment of a rotating credit association established in accordance with the principles described herein.

A rotating credit association is established which comprises a plurality of groups. Each group consists of approximately 250 members whose average contracted amount (the amount of money paid out to a member when the member is selected to receive a distribution from a fund managed by the association) is about $75,000. The average contracted term (the term over which the group members are obligated to contribute to the fund managed by the association) is 108 months (9 years). The average monthly contribution made by the group members is $694.44. Hence, the average total monthly contributions made to each group is about $173,611.

The average monthly award (that is, the average amount of money paid by the association to members of the group) on a per member basis is equal to the average contracted amount, and hence is $75,000. Hence, the association is a zero sum proposition (that is, the total amount of money paid into the group by its members over the contracted term is essentially equal to the amount of money paid out by the association over that term, exclusive of administration fees, adjustments for inflation, and other miscellaneous fees and factors).

In most months, two members of the group will receive an award, although in some months a greater or lesser number of members may receive awards. In those months where exactly two members receive awards, the total average monthly award is twice the average contracted amount, or $150,000. Hence, in those months, the residual added to the common fund is the difference between the amount awarded ($150,000) and the total monthly contributions (the total monthly contributions are $694.44×250, or $173,611). Thus, in those months, the residual amount added to the common fund is $23,611. When the total accumulated residuals are sufficiently large, three or more members of the group may then be designated to receive awards. The awards are granted in a rotating fashion such that each member receives an award of a predetermined amount of money at some point over a predetermined time period in which awards are made. The amount of money to be received by a member (the “contracted amount”), is specified in a contract between the member and the association or the management thereof.

The members of the group each pay a nonrefundable registration fee of 0.6% of the contracted amount, which in this example averages out to about $450. The members are also charged, at the time they receive a distribution from the fund, a registration complement of 2.16% of the contracted amount, which averages out to about $1,620. Group members are also charged an administration fee of 6.48% of the monthly contribution (this may be calculated as 0.0006 of the product of the monthly payment ($694.44) and the term (108 months)), or about $44.99 on average, and are required to pay a life and disability insurance premium of 0.03% of the contracted amount, or about $22.50 on average. Hence, the total average monthly payment to the fund is $761.93. In addition, the rotating credit association receives a first lien on any assets purchased with distributions from the fund to ensure that early awardees continue to make payments to the fund until all members have received a distribution.

This example underscores the ability of the association to deal with short-term liquidity problems and membership cancellations that have been a primary cause of catastrophic failure for the rotating credit associations known to the prior art. In particular, because the number of members in the group (250) exceeds the number of months (108) over which awards are made, there is a residual of $23,611 in the group fund in the very first month of operation (and a non-zero residual of varying amounts in most months thereafter), which enables the association to address any short-term liquidity problems encountered due to payment defaults or membership cancellations by group members. Liquidity problems and viability issues are further addressed by the registration fee and compliment, and through the retention by the association (or the management thereof) of a first lien in assets purchased with distributed funds.

Preferably, the members of each group in rotating credit associations established along the lines of the principles described herein are required to make payments to the association on a monthly basis, as illustrated in EXAMPLE 1. However, one skilled in the art will appreciate that the methods described herein are not limited, in their broadest sense, to any particular payment interval or to any particular number of payments. Thus, for example, payments could be made on a weekly, biweekly, monthly, bimonthly, quarterly, biannual or annual basis. The payment intervals may also be defined by certain dates, e.g., the 1^{st} of every month, or by fixed periods, e.g., every 30 or 60 days. Also, while the due date for payments is typically the same for all members of a particular group, and is preferably the same for all groups in the association, embodiments are also contemplated in which the due dates are not the same for all members of a particular group, or in which the due date is the same for all members of a particular group, but is not the same for all groups in the association. In some embodiments, the due dates for group members may be deliberately staggered to ensure a constant flow of receivables to a group fund or to the association or management thereof. The due dates may also be defined by external factors or actions. Thus, for example, in some embodiments, members of a group may arrange to have payments deducted from their paychecks, in which case the due date for a particular member may be controlled by the pay cycle of that member's employer.

The number of members in a group within rotating credit associations established along the lines of the principles described herein may also vary. However, the minimum number of group members will typically be dictated by the number of payment intervals or award dates such that the number of group members is greater than the number of payment intervals or award dates. For example, if the rotating credit association is set up to receive payments from a group Gᵢ of mᵢ members over a fixed period of time t and on a periodic basis t/dᵢ, wherein mᵢ and dᵢ are integers, then mᵢ>dᵢ. In some embodiments, the number of members in a group may also be determined by such factors as the average contracted amount, the average periodic payment that group members can afford to pay, and the average value or sales price of assets that group members intend to purchase with the award money disbursed to them. Typically, however, each group will have at least 20 members, preferably at least 100 members, more preferably about 200 to about 300 members, even more preferably about 225 to about 275 members, and most preferably about 250 members.

The number of payment cycles in rotating credit associations established along the lines of the principles described herein may be determined, in whole or in part, by such factors as the contracted amount, the average payment per periodic basis that a group member can afford to pay, and the average value or sales price of assets that a group member intends to purchase with the award money disbursed to that member, and the number of members in a group. The number of payment cycles may also be determined in whole or in part by various external factors. Thus, for example, the number of payment cycles for one or more group members may be determined in whole or in part by the frequency with which those group members are paid by their employers, or by a tax cycle.

The number and frequency of awards made over a given period of time by a rotating credit association established along the lines of the principles described herein may also vary. Typically, awards are made on a periodic basis and are preferably made a given period of time (e.g., a week) after the dates on which payments are due from members of a group. Preferably, the number and frequency of the awards are such that the total amount of money contributed to a common fund by members of a group is essentially equal to the total amount of money paid out from the common fund to members of the group, minus such miscellaneous costs as management or administration fees, insurance premiums, actualization fees or factors, registration fees and compliments, and the like.

The award schedule is preferably arranged such that, during most intervals, there is residual money in the group fund, since this improves the viability and short-term liquidity of the fund. This may be accomplished in various ways. For example, the awards may be scheduled such that no awards are made to members of a group until a certain amount of money is present in the group fund, or until a certain number of payments (e.g., 1, 2 or 3) are made by, or have been received from, group members. Some or all of this money may be maintained in the group fund until the later part of the award schedule, where it may be distributed to group members through, for example, extra awards. The awards may also be scheduled such that a larger number of awards are made later in (e.g., in the later half, third, or quarter of) the award schedule, or such that the aggregate value of the awards made in a later period of the award schedule is greater than the aggregate value of the awards made in an earlier period of the award schedule. In some embodiments, a percentage of each award (e.g., at least 2%, at least 5%, or at least 10%) or a fixed dollar amount (e.g., at least $300, at least $400 or at least $500) may be deducted from each award and may be held in the group fund or in a separate account until some point at or near the end of the award schedule, at which point some or all of this money may be distributed to the group members (preferably in these embodiments, the deduction is refunded to the original awardee at this point, possibly with interest).

Typically, at least one, and preferably at least two, awards are made on each date an award is scheduled, though on some award dates, three or more awards may be granted. The number of awards granted on a given date may also be determined, in whole or in part, by the amount of money remaining in a group fund after an initial award (or awards) is granted. For example, if two awards are initially scheduled and the total contracted amounts of the selected awardees is such that the amount of money remaining in the common fund exceeds the maximum contracted amount of all group members who have not yet received an award, then an additional award may be made.

The criteria used to select the eligible members of a group to receive awards in a rotating credit association established along the lines of the principles described herein may also vary. It is preferred, however, that these criteria effect only the order or priority in which awards are granted, and that each member of the group ultimately receives exactly one award. The selection of eligible members to receive awards may be random (e.g., by drawing) or non-random. In some embodiments employing a non-random selection process, awardees may be determined in whole or in part by voting amongst the group members, or by considering the payment history of group members. In other embodiments employing a non-random selection process, members of the group may elect to receive an amount of money lower than their contracted amount in exchange for receiving preferential consideration in the allocation of awards. In some such embodiments, an award may be given preferentially to the lowest bidder as determined, for example, by the group member willing to receive an award that is discounted by the largest amount. For purposes of determining the lowest bidder, the discount offered by a group member may be calculated as the absolute dollar amount of the discount, the discount as a percentage of the contracted amount, or by other suitable criteria. In some embodiments, the amount of the discount, or a portion thereof, may be distributed among the other members of the group (or a subset thereof), it may be applied as a credit against payments or fees owed by other members of the group (or a subset thereof), or it may be added to the amount of money awarded to other members of the group (or a subset thereof). For example, the amount of the discount (or a portion thereof) may be distributed among all group members (besides the lowest bidder) who are not in arrears in any of their payments at the time of the award and/or at the time of the distribution.

The criteria used to determine the eligibility of members of a group to receive awards in a rotating credit association established along the lines of the principles described herein may also vary. In some embodiments, a member of a group is ineligible to receive an award if they are in arrears by a predetermined number (typically at least one, and preferably at least two) of contributions, and/or if the total amount of the arrearage exceeds a given percentage of the contracted amount. In the later type of embodiment, the given percentage is typically at least about 0.5%, preferably at least about 0.75%, more preferably at least about 1%, and most preferably at least about 1.5% of either the contracted amount or the total payments owed by a member. In other embodiments, a member is eligible for an award even if that member is in arrears, but the outstanding amount, as well as, in some embodiments, a penalty fee, is deducted from the award. If a group member is charged a penalty fee, then that penalty fee, or a portion thereof, may be distributed among the other members of the group (or a subset thereof), it may be applied as a credit against payments or fees owed by other members of the group (or a subset thereof), it may be added to the amount of money awarded to other members of the group (or a subset thereof), or it may be retained by the association or its management. For example, the amount of the penalty (or a portion thereof) may be distributed among all group members who are not in arrears (or whose total arrearage does not exceed a specified dollar amount or percentage) in any of their payments at the time of the award and/or at the time of the distribution.

Various principles and procedures may govern the termination of a member from a group in a rotating credit association established along the lines of the principles described herein. Typically, such termination may be initiated by either the group member or by the association or the management thereof. Preferably, the association or management thereof may only terminate a group member for material breach of contract, such as failure to make one or more of the payments required under the contract between the member and the association or management thereof. On the other hand, it is preferred that members of a group may terminate at will, in which case it is preferred that, if the terminating member has not yet received an award, that member is refunded all payments made to date.

In some embodiments, the refunded amount may be exclusive of certain fees, such as the registration fee, insurance premiums, or the like, and/or it may be reduced by a predetermined amount or by a percentage. In some embodiments, a member incurs a contractual penalty by terminating, and the penalty is based on, or is proportional to, the contracted term or the number of contributions the member was required to make under the contract. Such a penalty may be specified, in a contract between the member and the association or the management thereof, as a percentage or as a number or fraction (preferably greater than 1) of the monthly contributions the member is required to make. Preferably, the penalty increases with the contracted term. If the penalty is termed as a number or fraction of the monthly contributions the member is required to make, then this penalty is typically equal to at least 1 contribution, and preferably at least 2 contributions; more preferably, the penalty is within the range of about 3 to about 5 contributions, and most preferably, the penalty is about 4 contributions. If the penalty is termed as a percentage of the contracted amount, then this percentage is typically within the range of about 0.5% to about 15%, preferably within the range of about 1.5% to about 10%, even more preferably within the range of about 2.5% to about 5%, and most preferably about 4%.

If a terminating member of a group has already received an award, it is preferred that the member is contractually obligated to pay the group or its management an amount of money equal to any remaining payments, plus any applicable termination penalties or fees. The payment of any outstanding payments may be ensured, for example, by the retention on the part of the association, or the management thereof, of a lien (preferably a first lien) on any assets procured with award money distributed to a group member.

The award money given to group members may be used to purchase various assets or services. Preferably, these assets or services are defined, at least generally, in a contract between the group member and the association or the management thereof. Such assets or services may include, without limitation, houses or improvements thereto; real estate; cars, trucks, boats, airplanes, or other vehicles; securities, including, for example, stocks and bonds; travel packages or expenses; and equipment, inventory or other business-related items or expenses.

Typically, the number of members mᵢ in a group Gᵢ and the number of intervals or dates dᵢ over which awards are made in rotating credit associations established along the lines of the principles described herein is such that the ratio mᵢ/dᵢ is greater than 1. Preferably, mᵢ/dᵢ is greater than about 1.5, more preferably, mᵢ/dᵢ is greater than about 2, and most preferably, mᵢ/dᵢ is within the range of about 2 to about 3. In some embodiments, the rotating credit association may be arranged such that the ratio of mᵢ to the number of payments a group member is required to make to the common fund falls within the preceding ranges, whether or not the value of mᵢ/dᵢ falls within the same ranges. Typically, mᵢ is at least 100, preferably mᵢ is greater than 150, more preferably mᵢ is greater than 200, and even more preferably, 250≦mᵢ≦450. Most preferably, mᵢ is about 360.

The number of groups in rotating credit associations established along the lines of the principles described herein may also vary. On one hand, it is preferred that the number of groups be large enough to afford economies of scale to the entity or corporation managing the association. On the other hand, it is recognized that a point of diminishing returns may be reached where further increases in the number of groups in the association provide a negligible increase, and perhaps even a decrease, in the economies of scale attendant to the management of the association. The optimal number of groups in the association may also be dictated by external factors, such as market saturation in a particular region, geographic boundaries, or regulatory considerations. For example, state business regulations may make it advantageous to arrange the rotating credit association along state boundaries, in which case the maximum number of groups in the association may be dictated by the market need for self-financing institutions in a particular jurisdiction. Typically, however, the rotating credit association will have a plurality of groups, and preferably, the rotating credit association will have at least 5 groups. More preferably, the rotating credit association will have a number of groups within the range of about 10 to about 500, and most preferably, the rotating credit association will have a number of member groups within the range of about 100 to about 300.

The monthly payment made by a member of a group to the rotating credit association or to the management thereof in a rotating credit association established in accordance with the teachings herein may include an administrative fee or other such component. The administrative fee is preferably defined by EQUATION I:

F_{A}=kTPₘ (EQUATION 1)

wherein

F_{A} is the administrative fee;

k is a constant;

T is the contract term (the number of time, usually in months, over which payments must be made; in some embodiments, T may instead be expressed as the number of payments required to be made); and

Pₘ is the average monthly payment.

In EQUATION 1, the value of k is typically at least 0.0001, preferably within the range of about 0.0002 to about 0.0010, more preferably within the range of about 0.0004 to about 0.0008, and most preferably about 0.0006. The administrative fee is typically at least 0.5%, preferably at least 1%, more preferably within the range of about 2 to about 10%, and most preferably within the range of about 5.5 to about 7.5% of the monthly payment made by the associate or group member.

The monthly payment made by a member of a group to the rotating credit association or to the management thereof in a rotating credit association established in accordance with the teachings herein may include an actualization factor or other such component. The actualization factor may be a function of, or be defined by, an economic index, factor, or lending rate. Thus, for example, the actualization factor may be based, in whole or in part, by the prime lending rate or by a consumer price index prevailing on one or more specified dates, or on other such rates or factors. Preferably, the actualization factor is based on the consumer price index U.S. city average for all items (seasonally adjusted), and even more preferably, the actualization factor is within the range of about 1 to about 3 times this index. The actualization factor may be applied at various intervals or on various dates to adjust the monthly payment required by a member of a group. Thus, for example, the actualization factor may be applied monthly, quarterly, seasonally, semi-annually, or annually.

The association or provider (that is, the entity which promotes a rotating credit association made in accordance with the teachings herein, or a group thereof) may be a group, partnership, corporation, or any of various other legal or informal entities. Preferably, the provider is a non-profit group, corporation or association. However, embodiments are also contemplated wherein the provider is an individual or an informal group or entity, such as a neighborhood association or civic group. The managing entity of a rotating credit association established in accordance with the principles described herein may be a group, partnership, corporation or other such entity. Preferably, the managing entity is a for-profit corporation. However, embodiments are also contemplated wherein the managing entity is simply an individual or group of individuals.

The various methodologies disclosed herein may be aided or implemented through the use of various software and computer programs. Such software and computer programs may be disposed in or recorded on or in various tangible media, including, but not limited to, various types of disks, drives, or memory devices, including hard drives, floppy disks, compact disks, and DVDs. Such disks, drives, or memory devices may be disposed in desk top or lap top computers, or in hand held personal assistant devices and the like.

### Example 2

This example illustrates one particular, non-limiting example of a contract which may be executed between the members of a group and the managing entity of a rotating credit association of the type disclosed herein. The contract is set forth in APPENDIX A. Some of the terms that are common to contracts of this type have been omitted for sake of brevity.

The various methodologies and systems disclosed herein may also be used in conjunction with, or as a component of, various existing or known consumer or commercial credit products or services, and various hybrids of these products or services with rotating credit associations are possible in accordance with the teachings herein. For example, as previously noted, some consumers, especially recent immigrants, have trouble qualifying for loans or credit because of the underwriting criteria involved. This may be due, for example, to lack a sufficient credit history. In such cases, the consumer's participation in an RCA can be employed as a mechanism or step to qualify the consumer for another form of consumer or business credit. Such credit may be in the form of a loan, a line of credit, a credit card, or other such credit vehicles as are known to the art.

As an example of the foregoing, a rotating credit association may be set up along the general lines of the RCA described in EXAMPLE 1, it being understood that various other types and forms of RCAs could also be used in the hybrid associations being described herein. The RCA may be associated with a creditor or lender, which may be a bank, a fund, a credit card company, or other type of credit or financial organization which offers a loan or credit product that may be used for the acquisition of a service or asset. The association between the RCA and the creditor or lender may be contractual, or the RCA may be a subsidiary or business unit of the creditor or lender (or vice versa) or may otherwise be associated with it. The creditor or lender may also be a shareholder of the RCA or may have some other financial interest or stake in the RCA (or vice versa). In some embodiments, a plurality of creditors or lenders may be associated with a single RCA. Thus, for example, a group or consortium of creditors or lenders may own, operate, be affiliated with, interact with, or and/or be shareholders of an RCA for the purposes described herein. Likewise, a single creditor or lender may own, operate, be affiliated with, interact with, or and/or be shareholders of a plurality of RCAs.

The creditor or lender will have a set of criteria that must typically be met before it will loan money or extend credit to an applicant, and the RCA will work with its members to enable them to meet some or all of these criteria. For example, the creditor or lender may require an applicant to have a credit history showing the timely payment of at least 36 months' worth of payments on an obligation before it will extend credit to the applicant. By participating in an RCA of the type described herein, the member of the RCA will meet this requirement after successfully participating in the RCA for three years (in the case of an RCA requiring monthly payments), provided all of the required payments are made in a timely manner.

As another example, the creditor or lender may require that an applicant has assets of a certain minimum value in order to qualify for a loan or for credit. This requirement may be met, at least in part, by using as an asset or as collateral the contract between the applicant and the RCA which requires the payment of an award to the applicant within a specified time interval. This requirement may also be met through assignment of the applicant's right to receive an award under the contract. Since the value of the contract increases with each payment made by a member of an RCA at least up until the time an award is made, this approach provides a means for steadily increasing the value of an applicant's assets up until the point where the applicant is able to qualify for a loan or for credit.

If an RCA is used to facilitate or enable an applicant to qualify for a loan or credit in accordance with the teachings herein, the obligations of the applicant to the RCA, after the applicant has qualified for the loan or credit, may remain the same or may change. For example, in some embodiments of the methodologies disclosed herein, the applicant's obligations to the RCA will be unaffected by his qualification for a loan or for credit. In these embodiments, for example, the qualification of the applicant for a loan or credit will simply serve as a separate and additional source of funds or credit for the applicant, though the RCA and the lender or creditor may still be associated as described above. In these embodiments, the association between the RCA and the creditor or lender may serve to provide a seamless transition from the applicant's initial participation in the RCA alone to the applicant's subsequent participation in both the RCA and a loan or credit vehicle. For example, when the applicant initially signs a contract with the RCA, he may also designate the loan or credit product he wishes to participate in when he becomes qualified for it. Upon qualification of the applicant, the RCA may notify the lender or creditor of the applicant's qualification, and the loan or credit may then be made available to the applicant with little or no further action required on the part of the applicant.

In other embodiments, the applicant's participation in the RCA is replaced or subsumed in whole or in part by the loan or credit that the applicant becomes qualified for. For example, an applicant may participate in an RCA and may make all required payments up until the time that the applicant qualifies for a loan or other credit. However, after the applicant qualifies for a loan, his participation in the RCA may be converted into participation in a conventional loan or credit vehicle. The required payments and obligations after conversion into a conventional loan or credit vehicle may be the same or different as those assumed originally under the RCA, and the amount of money loaned or made available as credit may be the same or different from the amount originally contracted for as an award in the RCA. In some embodiments, the applicant may be required to assign part or all of the award money contracted for with the RCA as a condition precedent for obtaining the conventional loan or credit vehicle.

In still other embodiments, the applicant's obligations to the RCA are affected by his qualification for a loan or for credit only in certain situations. For example, if the applicant receives an award from the RCA, the award itself may be sufficient to finance the acquisition of an asset or service. Since, in that case, the applicant may no longer have a need for a loan or credit, that applicant may elect or be allowed to proceed with his obligations to the RCA without interruption. On the other hand, if the applicant has not yet received an award at the time that he qualifies for a loan or for credit, his participation in the RCA may be converted into or subsumed by a loan or credit vehicle for which the applicant qualifies, or the loan or credit vehicle may be made available as a source of credit or funds in addition to the applicant's participation in the RCA.

Systems and methodologies for self-financing, and rotating credit associations incorporating or implementing these systems and methodologies, have been provided herein that offer an attractive alternative to conventional consumer credit and savings systems for persons, such as immigrants and minorities, who may have nontraditional credit histories or who are otherwise disadvantaged in the underwriting processes attendant to most consumer loans. The systems and methodologies, which feature rotating credit associations in which the number of group members making payments to a common fund is greater than the number of time intervals (typically months) or dates over which awards are made from the common fund, can tolerate a high percentage of defaults or membership cancellations by its participants without becoming insolvent.

The above description of the invention is illustrative, and is not intended to be limiting. It will thus be appreciated that various additions, substitutions and modifications may be made to the above described embodiments without departing from the scope of the present invention. Accordingly, the scope of the present invention should be construed solely in reference to the appended claims.

1. A system for financing the acquisition of an asset or service, comprising:
a plurality of groups G₁, . . . , Gₖ wherein, for i=1 to k, group Gᵢ consists of mᵢ members, each of whom are contractually obligated to make a predetermined number of periodic payments to a common fund Fᵢ; and
a managing entity which manages said plurality of groups;
wherein, for each group, the managing entity allocates to members of the group, on a rotating basis and on dᵢ different dates, proceeds from the common fund F for the acquisition of assets or services, and wherein mᵢ>dᵢ>0.

2. The system of claim 1, wherein each member of each group contracts to be allocated a predetermined amount of money, and wherein the total payments made by a member is proportional to the amount of money the member contracts to be allocated.

3. The system of claim 2, wherein each member of each group is allocated money exactly once.

4. The system of claim 1, wherein the amount of money a member of a group is allocated is a fixed percentage of the total payments made by that member.

5. The system of claim 1, wherein the managing entity allocates to a member of a group proceeds from the common fund for the acquisition of an asset, and wherein the managing entity retains a lien in the asset until the member makes all of the predetermined number of periodic payments.

6. The system of claim 1, wherein the predetermined number of periodic payments is the same for each member of a group.

7. The system of claim 1, wherein the predetermined number of periodic payments differs for at least two members of the same group in at least one of said plurality of groups.

8. The system of claim 1, wherein mᵢ/dᵢ>1.5.

9. The system of claim 1, wherein mᵢ/dᵢ>2.

10. The system of claim 1, wherein 2≧mᵢ/dᵢ<3.

11. The system of claim 1, wherein mᵢ>100.

12. The system of claim 1, wherein 100<mᵢ<300

13. The system of claim 1, wherein mᵢ>100 and wherein mᵢ/dᵢ>1.5.

14. A system for financing the acquisition of assets, comprising:
a group consisting of m members, each of whom is contractually obligated to make a predetermined number of periodic payments to a common find; and
an entity which manages said group; wherein the managing entity allocates to members of the group, on a rotating basis and on d different dates, proceeds from the common fund for the acquisition of assets, and wherein m>d>0.

15. A method for financing the acquisition of an asset or service for members of a group, comprising the steps of:
creating a group of associates, each of whom is contractually obligated to make payments on a first periodic basis to a common fund over a specified term in exchange for receiving an award in a contracted amount at some point during the term;
receiving payments from the group of associates; and
on a second periodic basis, identifying at least one associate who is eligible to receive an award, and distributing the award to that associate in an amount essentially equal to the amount contracted by that associate;
wherein the number of associates in the group is x, wherein the average number of payments that an associate in the group is required to make is n, and wherein x/n>1.

16. The method of claim 15, wherein x/n≧1.5.

17. The method of claim 16, wherein x/n≧2.

18. The method of claim 16, wherein 2≦x/n≦3.

19. The method of claim 16, wherein the periods of the first and second periodic basis are essentially the same.

20. The method of claim 19, wherein the periods of the first and second periodic basis is monthly.

21-58. (canceled)
